(19) United States
(12) Patent Application Publication
(10) Pub. No.: US 2017/0371170 A1
(43) Pub. Date: Dec. 28, 2017

(54) Display Device and Assembly Method Thereof

(71) Applicant: Wuhan China Star Optoelectronics Technology Co., Ltd., Wuhan (CN)

(72) Inventors: Hongqing CUI, Shenzhen (CN); Guowei ZHA, Shenzhen (CN)

(73) Assignee: Wuhan China Star Optoelectronics Technology Co., Ltd., Wuhan (CN)

(21) Appl. No.: 15/227,748

(22) Filed: Aug. 3, 2016

(30) Foreign Application Priority Data
Jun. 23, 2016 (CN) 2016104721465

(51) Int. Cl. G02B 27/22; G02B 7/00

(52) U.S. Cl. CPC G02B 27/2214; G02B 7/003

(57) ABSTRACT

A method of assembling a display device is proposed. The method includes: arranging an alignment imaging device over the lens layer, aligning a first alignment target of the display panel and a first alignment target of the lens layer, controlling the display panel to emit and obtaining the light passing through the lens layer with the alignment imaging device to form bright and dark stripes, arranging one or more second alignment targets on the display panel and adjusting the position of the lens layer so as to align the central line of a bright stripe in the bright and dark stripes to the second alignment targets, and adhering the display panel to the lens layer. By using the present disclosure, the precise alignment of the display panel and the lens layer is reflected rapidly. The yield rate increases. The three-dimensional display effect of the display device improves as well.

### BACKGROUND OF THE INVENTION

### 1. Field of the Invention

The present invention is related to the field of display technology, and more particularly, to a display device and an assembly method for the display device.

### 2. Description of the Prior Art

Stereovision is formed based on differences of binocular stereoscopic vision. The brain synthesizes two dimensional images from different viewing angles to reproduce depth and hierarchy of stereovision. For an auto-stereoscopic display, light through the liens is diffracted into different beams of left and right images which travel to left and right eyes.

With the development of the display technique, the requirement for the assembly accuracy of a display and a lens layer is increasing. If the alignment of the display and the lens layer is not accurate, the effect of stereovision will get worse, and even more seriously, stereovision will not be seen clearly. In addition, a conventional assembly method based on pure alignment targets is one type of off-line assembly techniques, so accuracy of alignment cannot be reflected real-time, and inspection of the following products or bias of the following products in use cannot be corrected in time. As a result, the yield rate of the products is low.

### SUMMARY OF THE INVENTION

An object of the present invention is to propose a display device and an assembly method for the display device to solve the above-mentioned problem.

According to the present invention, a method of assembling a display device is provided. The display device includes a display panel and a lens layer arranged on the display panel. The method includes steps of:

arranging an alignment imaging device over the lens layer;

primarily aligning a first alignment target of the display panel and a first alignment target of the lens layer;

controlling the display panel to emit light and obtaining the light passing through the lens layer with the alignment imaging device to form bright and dark stripes;

arranging one or more second alignment targets on the display panel and adjusting the position of the lens layer so as to align the central line of a bright stripe in the bright and dark stripes to the second alignment targets; and

adhering the display panel to the lens layer.

Furthermore, the step of arranging an alignment imaging device over the lens layer comprises: arranging the alignment imaging device over the central line of the lens layer, and setting a distance between the alignment imaging device and the lens layer to range from 10 centimeters (cm) to 100 cm.

Furthermore, the step of primarily aligning a first alignment target of the display panel and a first alignment target of the lens layer comprises: arranging a first alignment target of the display panel on an edge of the display panel and a first alignment target of the lens layer on an edge of the lens layer.

Furthermore, the step of arranging one or more second alignment targets on the display panel comprises: in a case of odd lens column of the lens layer, a second alignment target being arranged on a non-display zone near a central area of a display zone of the display panel and along a long side of the display panel; the central area of the display zone being located on a central line of the long side which the display zone corresponds to. The step of aligning the central line of the bright stripe in the bright and dark stripes to the second alignment targets comprises: aligning the central line of one bright stripe in the middle of the bright and dark stripes to the second alignment target.

Furthermore, the step of arranging one or more second alignment targets on the display panel comprises: in a case of even lens column of the lens layer, two second alignment targets being arranged on a non-display zone near a central area of a display zone of the display panel and along a long side of the display panel; the central area of the display zone being located on a central line of the long side which the display zone corresponds to. The step of aligning the central line of the bright stripe in the bright and dark stripes to the second alignment targets comprises: aligning the central line of two bright stripes in the middle of the bright and dark stripes to the two second alignment targets, respectively.

According to the present invention, a display device comprises a display panel, a lens layer adhered to and arranged on the display panel, and an alignment imaging device, arranged on the lens layer. The display panel comprises a first alignment target and one or more second alignment targets. The lens layer comprises a first alignment target. The alignment imaging device is configured to generate bright and dark stripes when light emitted from the display panel passes through the lens layer. The first alignment target of the display panel and the first alignment target of the lens layer are primarily aligned. A position of the lens layer is adjusted by aligning a center line of a bright stripe in the bright and dark stripes to the second alignment targets.

Furthermore, the alignment imaging device is arranged over the central line of the lens layer, and a distance between the alignment imaging device and the lens layer is in a range from 10 centimeters (cm) to 100 cm.

Furthermore, the first alignment target of the display panel is arranged on an edge of the display panel, and the first alignment target of the lens layer is arranged on an edge of the lens layer.

Furthermore, in a case of odd lens columns of the lens layer, a second alignment target is arranged on a non-display zone near a central area of a display zone of the display panel and along a long side of the display panel; the central area of the display zone is located on a central line of the long side which the display zone corresponds to; the central line of one bright stripe in the middle of the bright and dark stripes aligns to the second alignment target.

Furthermore, in a case of even lens columns of the lens layer, two second alignment targets are arranged on a non-display zone near a central area of a display zone of the display panel and along a long side of the display panel; the central area of the display zone is located on a central line of the long side which the display zone corresponds to; the central line of two bright stripes in the middle of the bright and dark stripes align to the two second alignment targets, respectively.

Compared with conventional technology, the display device comprises a display panel and a lens layer arranged on the display panel in the present invention. An alignment imaging device is arranged over the lens layer. A first alignment target of the display panel and a first alignment target of the lens layer are primarily aligned. The display panel is controlled to emit light, and the alignment imaging device obtains the light passing through the lens layer to form bright and dark stripes. One or more second alignment targets are arranged on the display panel. The position of the lens layer is adjusted to align the central line of a bright stripe in the bright and dark stripes to the second alignment target. The display panel is adhered to the lens layer. The rapid assembly technology is realized on the alignment imaging device. The precise alignment of the display panel and the lens layer is reflected real time. The yield rate increases. The three-dimensional display effect of the display device improves as well.

### BRIEF DESCRIPTION OF THE DRAWINGS

In order to more clearly illustrate the embodiments of the present invention or prior art, the following figures will be described in the embodiments are briefly introduced. It is obvious that the drawings are merely some embodiments of the present invention, those of ordinary skill in this field can obtain other figures according to these figures without paying the premise.

FIG. 1 is a flowchart of an assembly method for a display device according to a first embodiment of the present invention.

FIG. 2 is a schematic diagram of the structure of the display device.

FIG. 3 shows first alignment targets on the display panel of FIG. 2, and the first alignment target on a lens layer.

FIG. 4 shows bright and dark stripes sampled by the alignment imaging device of FIG. 2.

FIG. 5 shows second alignment targets of FIG. 2.

FIG. 6 shows a central line of a bright stripe aligning a second alignment target in the case of odd lens columns of the lens layer.

FIG. 7 shows a central line of a bright stripe aligning a second alignment target in the case of even lens columns of the lens layer.

### DETAILED DESCRIPTION OF THE PREFERRED EMBODIMENTS

Embodiments of the present invention are described in detail with the technical matters, structural features, achieved objects, and effects with reference to the accompanying drawings as follows. Specifically, the terminologies in the embodiments of the present invention are merely for describing the purpose of the certain embodiment, but not to limit the invention.

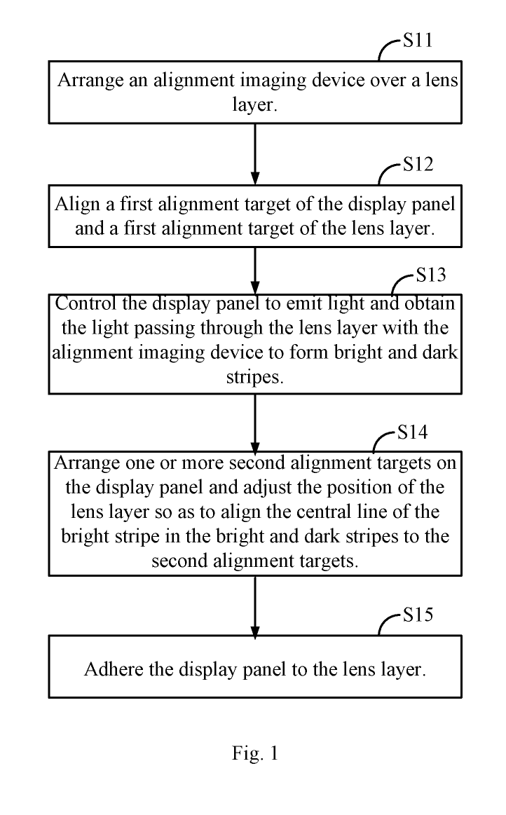

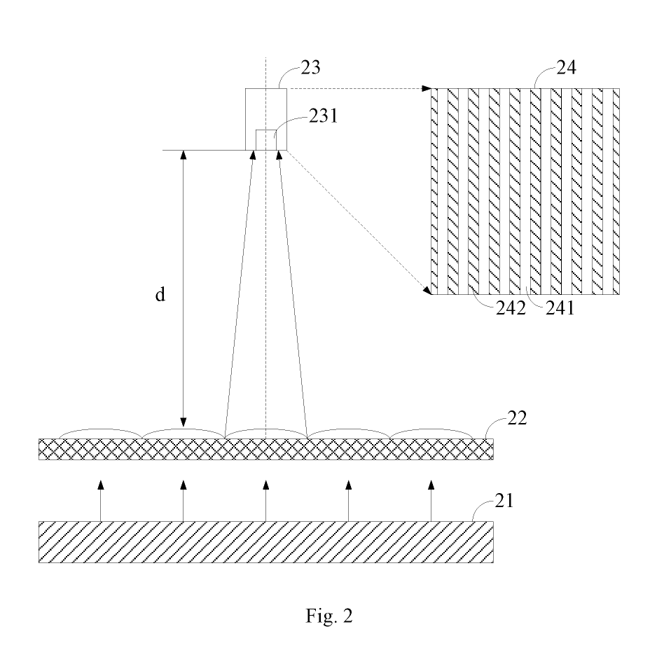

Please refer to FIG. 1 and FIG. 2. FIG. 1 is a flow chart of an assembly method for a display device according to a first embodiment of the present invention. FIG. 2 is a schematic diagram of the structure of the display device. The assembly method is applied to display devices. As FIG. 2 shows, the display device comprises a display panel 21 and a lens layer 22 arranged on the display panel 21. Preferably, a viewer sees three-dimensional (3D) images in the display device without wearing 3D glasses.

The lens layer 22 is used to regulate the traveling path of light supplied by the display panel 21 so that images formed by right-eye and left-eye pixels can enter a user's right and left eyes through different traveling paths respectively, to realize 3D technology. The lens layer 22 is a thin film lens layer or a liquid crystal lens layer. The lens layer 22 comprises at least a column lens formed by resin and a liquid crystal lens with a gradually changing refractive index.

Preferably, the display panel 21 is a self-illuminated organic light-emitting diode (OLED) display panel. In other embodiments, one having ordinary skill in the art can substitute the display panel 21 for a liquid crystal panel. For the liquid crystal panel, it is necessary to have a backlight module to supply a light source.

As FIG. 1 shows, the assembly method for the display device comprises:

Step S11: Arrange an alignment imaging device 23 over a lens layer 22.

The alignment imaging device 23 is arranged over the central line of the lens layer 22. In other words, the central line of the alignment imaging device 23 is located on the central line of the lens layer 22. The distance between the alignment imaging device 23 and the lens layer 22 is set as d. The distance d is larger than the focal length of the lens layer 22. Preferably, the distance d ranges from 10 centimeters (cm) to 100 cm.

Step S12: Align a first alignment target 211 of the display panel 21 and a first alignment target 221 of the lens layer 22.

The first alignment target 211 of the display panel 21 and the first alignment target 221 of the lens layer 22 are aligned to realize primary alignment.

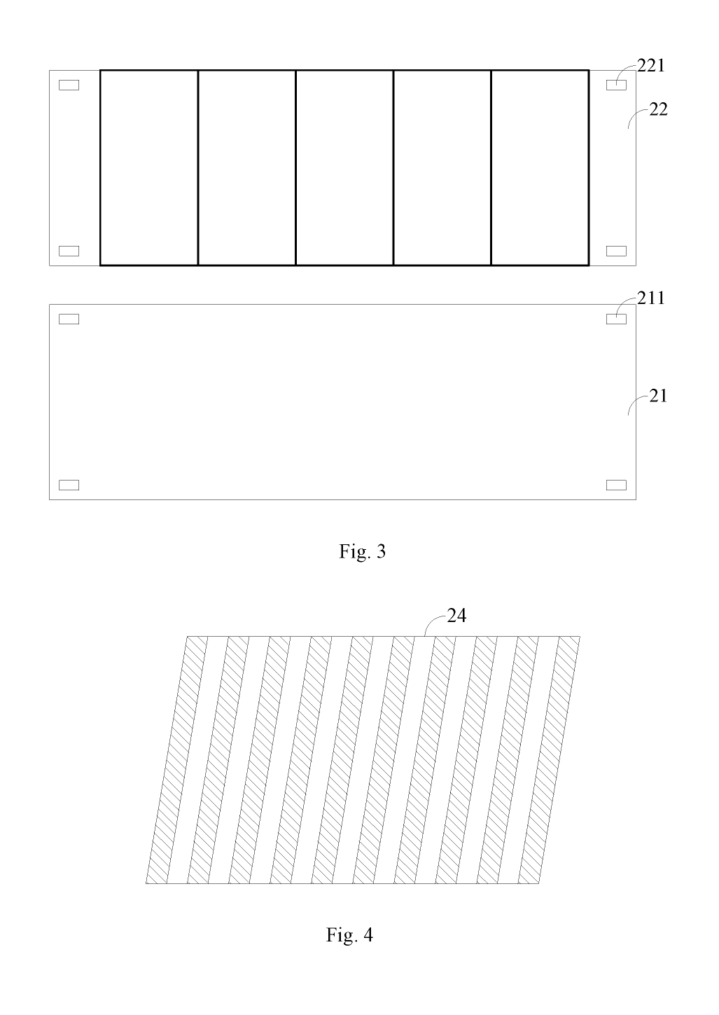

The first alignment target 211 is arranged on an edge of the display panel 21, and the first alignment target 221 is arranged on an edge of the lens layer 22, as FIG. 3 shows. In this embodiment, four first alignment targets 211 are respectively arranged on the edges of the display panel 21, and four first alignment targets 221 are respectively arranged on the edges of the lens layer 22. Specifically, the four first alignment targets 211 are respectively arranged on four corners of the display panel 21, and the four first alignment targets 221 are respectively arranged on four corners of the lens layer 22. The four first alignment targets 211 and the four first alignment targets 221 are aligned, respectively, to increase accuracy of primary alignment. In other embodiments, one or more first alignment targets 211 can be arranged on the edges of the display panel 21, and one or more first alignment targets 221 can be arranged on the edges of the lens layer 22 by one having ordinary skill in the art. For example, two first alignment targets 211 are arranged on a diagonal angle of the display panel 21, and two first alignment targets 221 are arranged on a diagonal angle of the lens layer 22.

Step S13: Control the display panel 21 to emit light and obtain the light passing through the lens layer 22 with the alignment imaging device 23 to form bright and dark stripes 24.

The display panel 21 emits light so that images with enough brightness can be shown on the display panel 21. Specifically, the images shown on the display panel 21 are lit up. The light is emitted by the display panel 21 through the lens layer 22. A camera 231 of the alignment imaging device 23 samples the light passing through the lens layer 22 to form the bright and dark stripes 24, as FIG. 2 shows. The images shown in the display panel 21 is sampled by the alignment imaging device 23 through the lens layer 22 to form the bright and dark stripes 24. The bright and dark stripes 24 comprise a bright stripe 241 and a dark stripe 242. The sum of the bright stripe 241 and the dark stripe 242 is equal to the sum of lens columns of the lens layer 22.

Relative to the display panel 21, the lens structure of the lens layer 22 is parallel-arranged. The bright and dark stripes 24 sampled by the alignment imaging device 23 is shown in FIG. 2. In other embodiments, one having ordinary skill in the art can substitute the lens structure of the lens layer 22 relative to the display panel 21 for the slant-arranged structure of the lens layer 22. At this time, the bright and dark stripes 24 sampled by the alignment imaging device 23 is shown in FIG. 4.

Step S14: Arrange one or more second alignment targets 212 on the display panel 21 and adjust the position of the lens layer 22 so as to align the central line of the bright stripe 241 in the bright and dark stripes 24 to the second alignment targets 212.

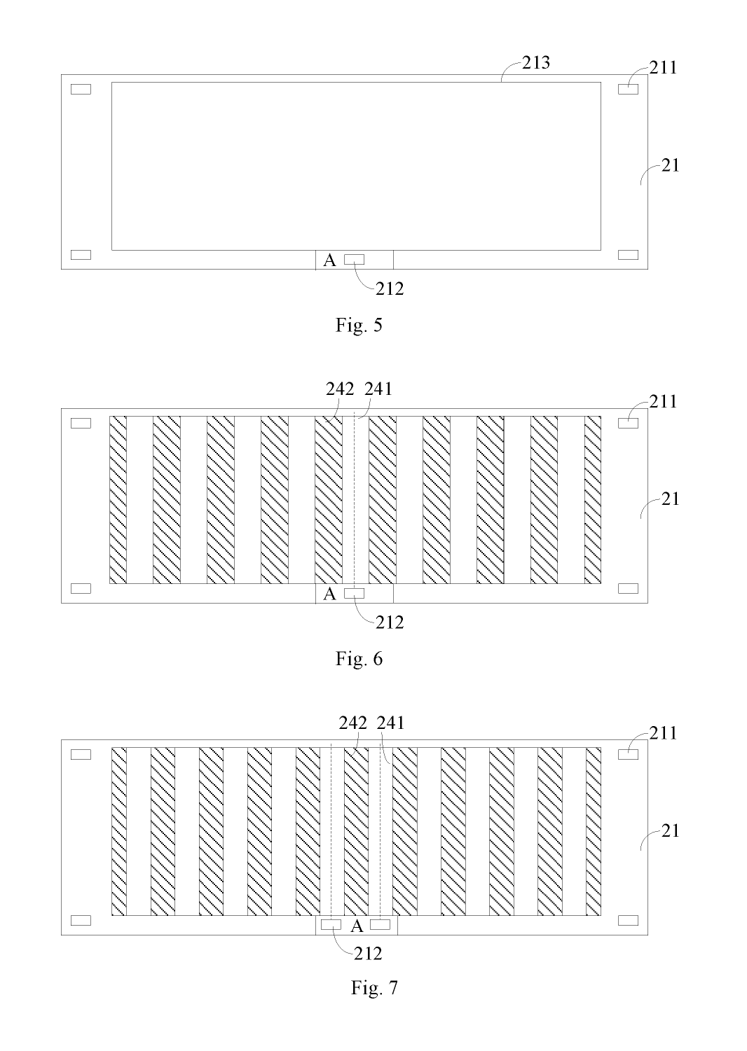

As FIG. 5 shows, the display panel 21 comprises a display zone 213. The display zone 213 is used to show images. One or more second alignment targets 212 are arranged on the display panel 21. That is, one or more second alignment targets 212 are arranged on a non-display zone near a central area A of the display zone 213 and along a long side of the display panel 21. The central area A of the display zone 213 is located on a central line corresponding to the long side of the display zone 213. That is, the central area A of the display zone 213 is preferably the central line of the long side of the display zone 213.

The second alignment target 212 is fabricated according to the black matrix (BM) structure at the edge of the display zone 213. The second alignment target 212 comprises a BM pattern (not shown) or a BM hollow structure (not shown). The second alignment target 212 has the same shape as the first alignment target 211.

The number of the second alignment target 212 is related to the number of lens columns of the lens layer 22 and is determined depending on the type of the lens layer 22 which the central area A corresponds to. The lens layer 22 may be a single-lens or a twin-lens layer.

When the lens columns of the lens layer 22 is an odd number (that is, the lens layer 22 which the central area A of the display zone 213 corresponds to is a single-lens layer), a second alignment target 212 is arranged on the non-display zone near the central area A and along the long side of the display panel 21, as shown in FIG. 6. The camera 231 of the alignment imaging device 23 searches for the second alignment target 212 near the central line of the display zone 213. The position of the lens layer 22 is adjusted. In other words, the position of the lens layer 22 relative to the display panel 21 is adjusted using the multi-dimensional device (not shown) to align the central line of the bright stripe 241 in the bright and dark stripes 24 to the second alignment targets 212 and to align the central line of one of the bright stripes 241 in the middle of the bright and dark stripes 24 to the second alignment target 212. For example, the bright and dark stripes 24 comprises nine bright stripes 241. The central line of a bright stripe 241 (i.e., the fifth bright stripe 241) arranged in the middle of the bright and dark stripes 24 aligns to the second alignment target 212. After aligning the display panel 21 and the lens layer 22, go to Step S15.

When the lens columns of the lens layer 22 is an even number (that is, the lens layer 22 which the central area A of the display zone 213 corresponds to is a twin-lens layer), two second alignment targets 212 are arranged on the non-display zone near the central area A and along the long side of the display panel 21, as shown in FIG. 7. The camera 231 of the alignment imaging device 23 searches for the second alignment target 212 near the central line of the display zone 213. The position of the lens layer 22 is adjusted. In other words, the position of the lens layer 22 relative to the display panel 21 is adjusted using the multi-dimensional device to align the central line of the bright stripe 241 in the bright and dark stripes 24 to the second alignment targets 212 and to align the central line of the two bright stripes 241 in the middle of the bright and dark stripes 24 to the two second alignment targets 212, respectively. For example, the bright and dark stripes 24 comprises ten bright stripes 241. The central line of the two bright stripes 241 in the middle of the bright and dark stripes 24 (i.e., the fifth bright stripe 241 and the sixth bright stripe 241) align to the two second alignment targets 212, respectively. After aligning the display panel 21 and the lens layer 22, go to Step S15.

In this embodiment, the multi-dimensional device adjusts the position of the lens layer 22 relative to the display panel 21. That is, the position of the lens layer 22 relative to the display panel 21 is adjusted by the multi-dimensional device. Specifically, the angle of the lens layer 22 is adjusted, and the lens layer 22 is shifted.

Step S15: Adhere the display panel 21 to the lens layer 22.

The aligned display panel 21 and lens layer 22 are adhered to each other. At this stage, the assembly of the display device is complete.

The first alignment target 211 and the first alignment target 221 are primarily aligned. Afterwards, one or more second alignment targets 212 are arranged on the display panel 21. The position of the lens layer 22 is adjusted so as to align the central line of the bright stripe 241 in the bright and dark stripes 24 to the second alignment targets 212 to realize precise alignment. The rapid assembly technology is realized on the alignment imaging device 23. The precise alignment of the display panel 21 and the lens layer 22 is reflected real time. The yield rate increases. The three-dimensional display effect of the display device is improved as well.

The present invention further proposes a display device in the first embodiment. The display device is described based on the above-mentioned assembly method for the display device. As FIG. 2 shows, the display device comprises a display panel 21, a lens layer 22 arranged on the display panel 21. Preferably, the display device has a function of realizing three-dimensional (3D) technology.

The lens layer 22 is used to regulate the traveling path of light supplied by the display panel 21 so that images formed by right-eye and left-eye pixels can enter the user's right and left eyes through different traveling paths respectively to realize 3D technology. The lens layer 22 is a thin film lens layer or a liquid crystal lens layer. The lens layer 22 comprises at least a column lens formed by resin and a liquid crystal lens with a gradually changing refractive index.

Preferably, the display panel 21 is a self-illuminated OLED display panel. In other embodiments, one having ordinary skill in the art can substitute the display panel 21 for a liquid crystal panel. For the liquid crystal panel, it is necessary to have a backlight module to supply a light source.

The alignment imaging device 23 is arranged over the central line of the lens layer 22. In other words, the central line of the alignment imaging device 23 is located on the central line of the lens layer 22. The distance between the alignment imaging device 23 and the lens layer 22 is set as d. The distance d is larger than the focal length of the lens layer 22. Preferably, the distance d ranges from 10 cm to 100 cm.

The first alignment target of the display panel 21 and the first alignment target 221 of the lens layer 22 are primarily aligned. That is, the first alignment target 211 is aligned to the first alignment target 221 to realize primary alignment.

A first alignment target 211 is arranged on an edge of the display panel 21, and a first alignment target 221 is arranged on an edge of the lens layer 22, as FIG. 3 shows. In this embodiment, four first alignment targets 211 are arranged on the edges of the display panel 21, and four first alignment targets 221 are arranged on the edges of the lens layer 22. Specifically, the four first alignment targets 211 are arranged on four corners of the display panel 21, respectively, and the four first alignment targets 221 are arranged on four corners of the lens layer 22, respectively. The four first alignment targets 211 and the four first alignment targets 221 are aligned, respectively, to increase accuracy of primary alignment. In other embodiments, one or more first alignment targets 211 can be arranged on the edges of the display panel 21, and one or more first alignment targets 221 can be arranged on the edges of the lens layer 22 by one having ordinary skill in the art. For example, two first alignment targets 211 are arranged on a diagonal angle of the display panel 21, and two first alignment targets 221 are arranged on a diagonal angle of the lens layer 22.

The display panel emits light. The alignment imaging device 23 obtains the light passing through the lens layer 22 to form bright and dark stripes 24. The display panel 21 emits light so that images with enough brightness can be shown on the display panel 21. Specifically, the images shown on the display panel 21 are lit up. The light is emitted by the display panel 21 through the lens layer 22. A camera 231 of the alignment imaging device 23 samples the light from the lens layer 22 to form the bright and dark stripes 24, as FIG. 2 shows. The images shown in the display panel 21 is sampled by the alignment imaging device 23 through the lens layer 22 to form the bright and dark stripes 24. The bright and dark stripes 24 comprises a bright stripe 241 and a dark stripe 242. The sum of the bright stripe 241 and the dark stripe 242 is equal to the sum of lens columns of the lens layer 22.

In this embodiment, relative to the display panel 21, the lens structure of the lens layer 22 is parallel-arranged. The bright and dark stripes 24 sampled by the alignment imaging device 23 is shown in FIG. 2. In other embodiments, one having ordinary skill in the art can substitute the lens structure of the lens layer 22 relative to the display panel 21 for the slant-arranged structure of the lens layer 22. At this time, the bright and dark stripes 24 sampled by the alignment imaging device 23 is shown in FIG. 4.

One or more second alignment targets 212 are arranged on the display panel 21. The position of the lens layer 22 is adjusted so as to align the central line of the bright stripe 241 in the bright and dark stripes 24 to the second alignment targets 212. As FIG. 5 shows, the display panel 21 comprises a display zone 213. The display zone 213 is used to show images. One or more second alignment targets 212 are arranged on the display panel 21. That is, one or more second alignment targets 212 are arranged on the non-display zone near a central area A of the display zone 213 and along a long side of the display panel 21. The central area A of the display zone 213 is located on a central line corresponding to the long side of the display zone 213. That is, the central area A of the display zone 213 is preferably the central line of the long side of the display zone 213.

The second alignment target 212 is fabricated according to the black matrix (BM) structure at the edge of the display zone 213. The second alignment target 212 comprises a BM pattern (not shown) or a BM hollow structure (not shown). The second alignment target 212 has the same shape as the first alignment target 211.

The number of the second alignment target 212 is related to the number of lens columns of the lens layer 22 and is determined depending on the type of the lens layer 22 which the central area A corresponds to. The lens layer 22 may be a single-lens or a twin-lens layer.

When the lens columns of the lens layer 22 is an odd number (that is, the lens layer 22 which the central area A of the display zone 213 corresponds to is a single-lens layer), a second alignment target 212 is arranged on the non-display zone near the central area A and along the long side of the display panel 21, as shown in FIG. 6. The camera 231 of the alignment imaging device 23 searches for the second alignment target 212 near the central line of the display zone 213. The position of the lens layer 22 relative to the display panel 21 is adjusted using the multi-dimensional device to align the central line of the bright stripe 241 in the bright and dark stripes 24 to the second alignment targets 212 and to align the central line of one of the bright stripes 241 in the middle of the bright and dark stripes 24 to the second alignment target 212. For example, the bright and dark stripes 24 comprise nine bright stripes 241. The central line of a bright stripe 241 (i.e., the fifth bright stripe 241) arranged in the middle of the bright and dark stripes 24 aligns to the second alignment target 212.

When the lens columns of the lens layer 22 is an even number (that is, the lens layer 22 which the central area A of the display zone 213 corresponds to is a twin-lens layer), two second alignment targets 212 are arranged on the non-display zone near the central area A and along the long side of the display panel 21, as shown in FIG. 7. The camera 231 of the alignment imaging device 23 searches for the two second alignment targets 212 near the central line of the display zone 213. The position of the lens layer 22 is adjusted. In other words, the position of the lens layer 22 relative to the display panel 21 is adjusted using the multi-dimensional device to align the central line of the bright stripe 241 in the bright and dark stripes 24 to the second alignment targets 212 and to align the central line of the two bright stripes 241 in the middle of the bright and dark stripes 24 to the two second alignment targets 212, respectively. For example, the bright and dark stripes 24 comprise ten bright stripes 241. The central line of the two bright stripes 241 in the middle of the bright and dark stripes 24 (i.e., the fifth bright stripe 241 and the sixth bright stripe 241) align to the two second alignment targets 212, respectively.

In this embodiment, the multi-dimensional device adjusts the position of the lens layer 22 relative to the display panel 21. That is, the position of the lens layer 22 relative to the display panel 21 is adjusted by the multi-dimensional device. Specifically, the angle of the lens layer 22 is adjusted, and the lens layer 22 is shifted.

The aligned display panel 21 and lens layer 22 are adhered to each other. At this stage, the assembly of the display device is complete.

In sum, the display device comprises a display panel and a lens layer arranged on the display panel in the present invention. An alignment imaging device is arranged over the lens layer. A first alignment target of the display panel and a first alignment target of the lens layer are primarily aligned. The display panel is controlled to emit light, and the alignment imaging device obtains the light passing through the lens layer to form bright and dark stripes. One or more second alignment targets are arranged on the display panel. The position of the lens layer is adjusted to align the central line of a bright stripe in the bright and dark stripes to the second alignment target. The display panel is adhered to the lens layer. The rapid assembly technology is realized on the alignment imaging device. The precise alignment of the display panel and the lens layer is reflected real time. The yield rate increases. The three-dimensional display effect of the display device improves as well.

Above are embodiments of the present invention, which does not limit the scope of the present invention. Any modifications, equivalent replacements or improvements within the spirit and principles of the embodiment described above should be covered by the protected scope of the invention.

1. A method of assembling a display device, the display device comprising a display panel and a lens layer arranged on the display panel, and the method comprising steps of:
arranging an alignment imaging device over the lens layer;
primarily aligning a first alignment target of the display panel and a first alignment mark of the lens layer;
controlling the display panel to emit light and obtaining the light passing through the lens layer with the alignment imaging device to form bright and dark stripes;
arranging one or more second alignment targets on the display panel and adjusting the position of the lens layer so as to align the central line of a bright stripe in the bright and dark stripes to the second alignment targets;
adhering the display panel to the lens layer.

2. The method of claim 1, wherein the step of arranging an alignment imaging device over the lens layer comprises:
arranging the alignment imaging device over the central line of the lens layer, and setting a distance between the alignment imaging device and the lens layer to range from 10 centimeters (cm) to 100 cm.

3. The method of claim 1, wherein the step of primarily aligning a first alignment target of the display panel and a first alignment mark of the lens layer comprises:
arranging a first alignment target of the display panel on an edge of the display panel and a first alignment mark of the lens layer on an edge of the lens layer.

4. The method of claim 1, wherein the step of arranging one or more second alignment targets on the display panel comprises:
in a case of odd lens column of the lens layer, a second alignment target being arranged on a non-display zone near a central area of a display zone of the display panel and along a long side of the display panel; the central area of the display zone being located on a central line of the long side which the display zone corresponds to;
the step of aligning the central line of the bright stripe in the bright and dark stripes to the second alignment targets comprises:
aligning the central line of one bright stripe in the middle of the bright and dark stripes to the second alignment target.

5. The method of claim 1, wherein the step of arranging one or more second alignment targets on the display panel comprises:
in a case of even lens column of the lens layer, two second alignment targets being arranged on a non-display zone near a central area of a display zone of the display panel and along a long side of the display panel; the central area of the display zone being located on a central line of the long side which the display zone corresponds to;
the step of aligning the central line of the bright stripe in the bright and dark stripes to the second alignment targets comprises:
aligning the central line of two bright stripes in the middle of the bright and dark stripes to the two second alignment targets, respectively.

6. A display device comprising:
a display panel, comprising a first alignment target and one or more second alignment targets; and
a lens layer, adhered to and arranged on the display panel, comprising a first alignment mark;
an alignment imaging device, arranged on the lens layer, configured to generate bright and dark stripes when light emitted from the display panel passes through the lens layer;
wherein the first alignment target of the display panel and the first alignment mark of the lens layer are primarily aligned, and
wherein a position of the lens layer is adjusted by aligning a center line of a bright stripe in the bright and dark stripes to the second alignment targets.

7. The display device of claim 6, wherein the alignment imaging device is arranged over the central line of the lens layer, and a distance between the alignment imaging device and the lens layer is in a range from 10 centimeters (cm) to 100 cm.

8. The display device of claim 6, wherein the first alignment target of the display panel is arranged on an edge of the display panel, and the first alignment mark of the lens layer is arranged on an edge of the lens layer.

9. The display device of claim 6, wherein in a case of odd lens columns of the lens layer, a second alignment target is arranged on a non-display zone near a central area of a display zone of the display panel and along a long side of the display panel; the central area of the display zone is located on a central line of the long side which the display zone corresponds to; the central line of one bright stripe in the middle of the bright and dark stripes aligns to the second alignment target.

10. The display device of claim 6, wherein in a case of even lens columns of the lens layer, two second alignment targets are arranged on a non-display zone near a central area of a display zone of the display panel and along a long side of the display panel; the central area of the display zone is located on a central line of the long side which the display zone corresponds to; the central line of two bright stripes in the middle of the bright and dark stripes align to the two second alignment targets, respectively.
